(19) United States
(12) Patent Application Publication
(10) Pub. No.: US 2007/0296723 A1
(43) Pub. Date: Dec. 27, 2007

(54) ELECTRONIC SIMULATION OF EVENTS VIA COMPUTER-BASED GAMING TECHNOLOGIES

(75) Inventor: William Williams, (US)

Correspondence Address: TOWNSEND AND TOWNSEND AND CREW LLP/EA, TWO EMBARCADERO CENTER, 8TH FLOOR, SAN FRANCISCO, CA, 94111, US

(73) Assignee: Electronic Arts Inc., Redwood City, CA (US)

(21) Appl. No.: 11/426,579

(22) Filed: Jun. 26, 2006

(51) Int. Cl. G06T 13/00

(52) U.S. Cl. 345/473

(57) ABSTRACT

Systems and methods for electronic simulation of events via computer-based gaming technologies are provided. Data relating to an event such as a sports games is received containing event object information. Events objects can be, for example, players on a field or objects relating to the event environment. A game object processing module correlates the event objects to game event objects. A video game console performs a game simulation using the game event objects, by applying the event data to the event objects, and then displaying the game simulation on the game console. The result is a simulation of the event via the game console.

### FIELD OF THE INVENTION

The present invention relates to electronic games in general and in particular to systems and methods for simulating events using computer-based gaming technologies.

### BACKGROUND OF THE INVENTION

The viewer of a sporting event such as a football game typically sees the event through his own eyes and from the vantage point of where he is sitting. For example, if the viewer is seated at the 50-yard line, he views the game from that position and at that angle only. The viewer does not see the game from point of view of the players on the field or of the reporter in the press box.

If the viewer is watching the event on television, then the viewer is provided additional viewing angles by virtue of the fact that multiple television cameras are located at various fixed and restricted locations on and above the playing field. These cameras can record the event from different angles, thus providing the television viewer with additional vantage points for viewing. However, since the particular camera angles and footage are chosen by the broadcaster of the event, the television viewer has no control over which viewing angles he actually sees on his television set.

By recording the sporting event to a videotape or DVD, the viewer can replay the event later as a recorded event. This provides the viewer with the opportunity to see the sporting event again, but still from the same viewing points as were presented in the live event. The viewer cannot view the event from angles and points of view that are not available in the original recording of the event.

Sometimes a viewer cannot record an event that he wishes to see, for example, if the event is only available on radio and not on television. With respect to sporting events, this typically occurs for sports teams which do not provide a sufficient audience for a television broadcast. For example, in college sports there are many more teams than there are broadcasts available. The result for a sports fan of a college team that draws a limited crowd or is not at the higher standings in the league is limited to radio or Internet broadcasts if he wishes to follow his team's games. In this instance, the viewer only has the option of listening to the broadcast of the event. This limits the viewer's experience of the event even more.

Thus, it is desired to provide electronic simulation of events to provide visual representations of event data, and to provide ways of exploring previously unavailable views of the event data.

### BRIEF SUMMARY OF THE INVENTION

Systems and methods for electronic simulation of events via computer-based gaming technologies are provided. Data relating to an event such as a sports games is received containing event object information. Events objects can be, for example, players on a field or objects relating to the event environment. A game object processing module correlates the event objects to game event objects. A video game console performs a game simulation using the game event objects, by applying the event data to the event objects, and then displaying the game simulation on the game console. The result is a simulation of the event via the game console.

The following detailed description together with the accompanying drawings will provide a better understanding of the nature and advantages of the present invention.

### BRIEF DESCRIPTION OF THE DRAWINGS

FIG. 1 is a diagram illustrating a game environment in accordance with an embodiment of the present invention.

FIG. 2 is a block diagram illustrating a game environment and data flow in accordance with an embodiment of the present invention.

FIG. 3 is a diagram illustrating relationships among various data and objects in accordance with an embodiment of the present invention.

FIG. 4 is a block diagram illustrating a system for collecting and simulating event data in accordance with an embodiment of the present invention.

FIG. 5 is a flow diagram illustrating a method for collecting event data.

FIG. 6 is a flow diagram illustrating a process for simulating event data in accordance with an embodiment of the present invention.

FIG. 7 illustrates a game system for providing one or more games for a user according to an embodiment of the present invention.

FIG. 8 illustrates an embodiment of a game device according to an embodiment of the present invention.

### DETAILED DESCRIPTION OF THE INVENTION

In accordance with an embodiment of the present invention, event data can be used as input to an electronic simulation of an event. These data can be collected, processed, broadcast and simulated for the viewing public via video games. Video games can perform the electronic simulation by incorporating the collected data and applying them to game objects interacting in a game environment. This will enable a person to experience a live football game as depicted by their football video game rather than as a television broadcast.

The term “electronic simulation” generally refers to a computer-bases re-creation of an event. In an embodiment of the present invention, this electronic simulation can be carried out on a gaming console that is running game software that is relevant to the event. For example, if the event is football, the game console can be running the football game Madden™, published by Electronic Arts Inc., or any other sports game which provides the capability to simulate events based on event data input. The game console can be a PlayStation2™, Xbox™, or Nintendo™, but is not limited to these particular examples.

The term “event” generally refers to events of interest. An event can be a sporting event, such as a football, basketball, baseball, soccer, hockey, golf, tennis, and auto racing, but is not limited to sports. The event can also be a non-sporting event such as a re-creation of a music concert, public gathering, courtroom event, or an airline flight.

In accordance with an embodiment of the present invention, a user can witness and experience an event by viewing and/or interacting with a video game which is made to mimic the real event. For example, a football game such as Madden™ can made to mimic a real sporting event such as a live football game. The electronic simulation provides additional viewing options. For example, the user can experience the sport “through the eyes” of a player by viewing the simulation from the player's location and perspective. The user can take advantage of in-game virtual camera placement and movement to view the simulated event from locations on or off the field of play without the interference and physical limitations found with real cameras. The entire event may be saved for replay and analysis. The replay can be viewed from different angles, providing increased information for analysis. (For example, a football play can be viewed from front, behind, side and above which will enable the viewer to see how each of the players performed based on their relative positions as seen from different viewpoints.)

The term “live data” refers to data that is relevant to a particular point in time. For example, live data can be information about a person's position at a point in time. Live data can also be information about particulars of the event such as the score, status, game clock, venue, etc. This data can be collected at the time it occurs (live) but can also include data that is collected afterward by other means such as extrapolation from video recordings.

The term “realtime” refers to the act of collecting, processing, transmitting and producing a simulation as it occurs in time. Realtime is a benefit to the utilization of the data, and the experience thereby created, due to the immediate nature of spectating an event, particularly a sporting event. Reproduction of an event may also be non-realtime, as in replaying a simulation for review, analysis or coaching purposes. In accordance with an embodiment of the present invention, an electronic simulation provides a visual representation of an event where one was not previously available, for example, in the situation where a person only has access to audio event data such as a radio broadcast.

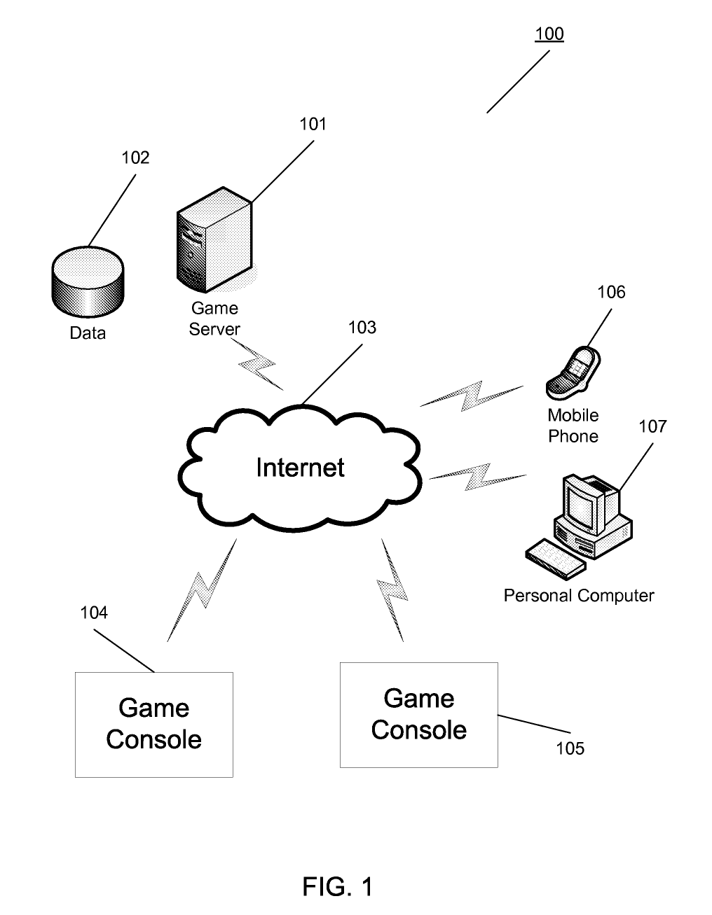

FIG. 1 is a diagram illustrating a game environment 100 in accordance with an embodiment of the present invention. A game server 101 has access to event data 102 and can transmit that event data 102 over the Internet 103 to various game consoles 104, 105. Electronic simulation of the event data 102 can be performed by the game consoles 104, 105 for viewing by individuals at those locations. In another embodiment of the present invention, the game server 101 performs the electronic simulation of the event data and transmits the resulting simulation of the event over the Internet 103 to other game devices such as a personal computer 107 or a handheld device 106 such as a mobile phone.

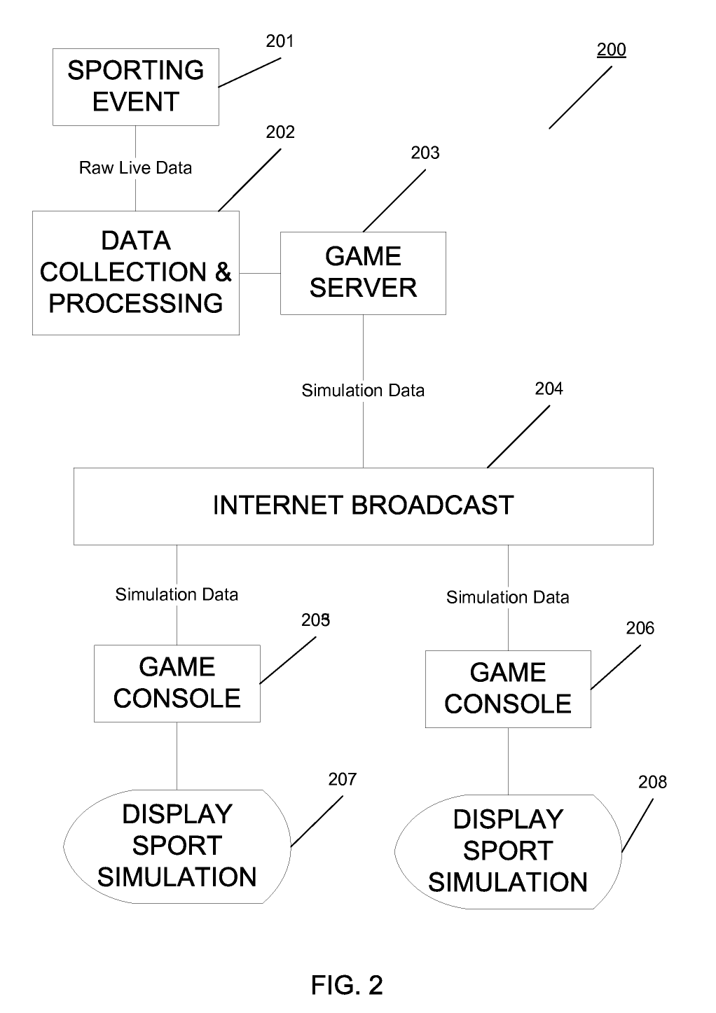

FIG. 2 is a block diagram 200 illustrating a game environment and data flow in accordance with an embodiment of the present invention. Raw live data relating to a sporting event 201, such as a football game, is collected and processed. The type of data that is collected can come from a variety of sources and generally relates to some aspect of the event. For example, position data for the people on the field can be collected by having the players, referees and coaches wear tracking devices which provide data that can be used for determining each person's position at any point in time. This raw live data information can be continually collected and processed by a game server 203 and broadcast over the Internet 204 as simulation data, as shown.

A plurality of game consoles 205, 206 can receive the simulation data over from the Internet broadcast 204 and display a simulation of the sporting event that is created in the sport game that is installed on the game console. For example, a game console running football game software can receive the simulated event data over the Internet broadcast and use that to recreate an accurate simulation of a football game on a display 207, 208. The video game receives the broadcast data and uses this data to recreate the football game.

Real actions can be recreated in the video game including player formations on the field, the execution of the play by the players, a quarterback's signaling motions, and even facial expressions and commentator dialog. In an embodiment of the present invention, the electronic simulation displayed by the video game can be produced from data that is collected live during the sporting event, or the data can be collected by processing archived data and/or videos to extract the desired information. Event data may be stored and later used to recreate an event on demand. In an embodiment of the present invention, the event is recreated on the game console via a video game that is installed thereon. For example, a user may replay last year's Super Bowl game, or a full season of games (play-by-play) as depicted by a football video game. Coaches may use event data to play last week's game for analysis. Statisticians may process the data to compile detailed information about every aspect of the game.

In addition to recreating the action on the field, virtual cameras available in the video game can provide the ability for the user to view the game from any perspective in the virtual game space. This provides an experience that was not previously available to the user. In particular, this experience is not available to a user watching a television broadcast of the game. The television user is restricted to the views that are presented by the fixed and restricted locations of the cameras.

In another example, the collected data can relate to positions of race cars on a race track in a network television broadcast, and the simulated data can be displayed on a game console using a racing game such as NASCAR™, published by Electronic Arts Inc.

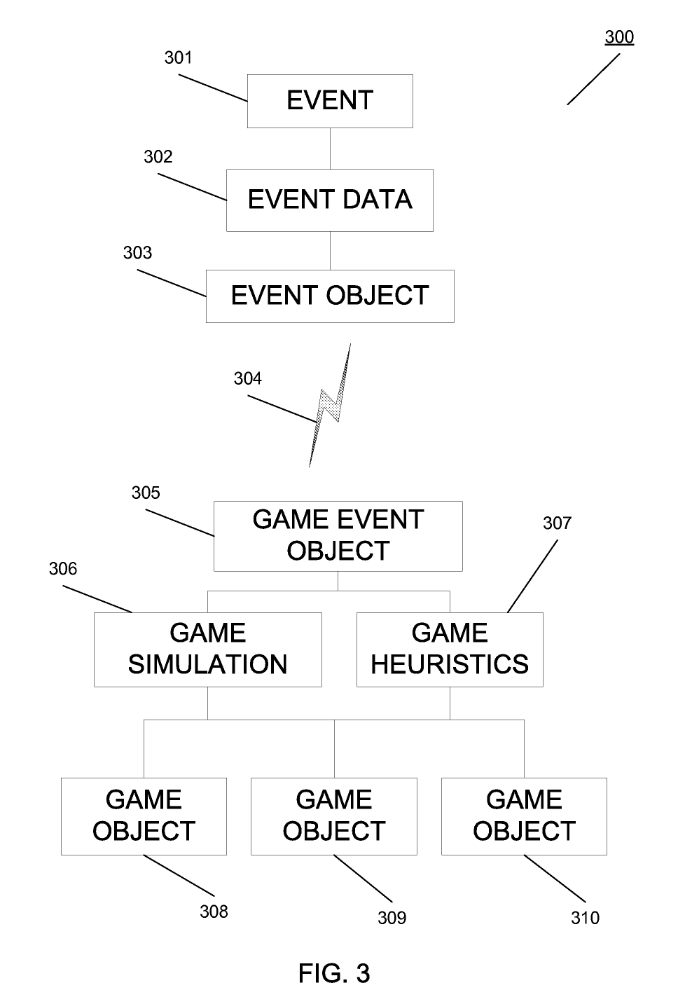

FIG. 3 is a diagram 300 illustrating relationships among various data and objects in accordance with an embodiment of the present invention. An event object 303 is derived from event data 202 that is collected at an event 301. The event object 303 is transmitted 304, typically via a game server, to a game console which transforms the event object 303 into a game event object 305 that is relevant for the particular game that is installed on the game console. For example, game event objects relating to positions of cars on a race track would be relevant for a racing video game such as NASCAR™. Game event objects relating to the positions and speed of hockey players skating around an ice rink and their body impact on each other as they push each other into the boards during a game would be relevant for a hockey video game. Game event objects relating to information such as hand gestures and throwing motions of players and referees would be relevant to many sport games including football, baseball and hockey. Game event objects relating to the curvature and speed of a player's swinging an object is relevant to baseball player swinging a baseball bat and a golfer swinging a golf club.

Game event objects 305 are not limited to the particular players in the game, however, and can also include aspects of the game environment such as weather (wind, sun, rain, snow, clouds, temperature, etc.) and even emotional factors such as background stories that relate to the players, rivalry between teams and between players, and even the player's moods.

The game event object 305 can include data that is relevant to the game simulation 306, which then directs a game object 380-310 to perform some action. The game event object 305 can include information about game heuristics 307, which can affect other aspects of the game objects 308-310. The game objects 308-310 can be affected by the game simulation 306, game heuristics 307 or both.

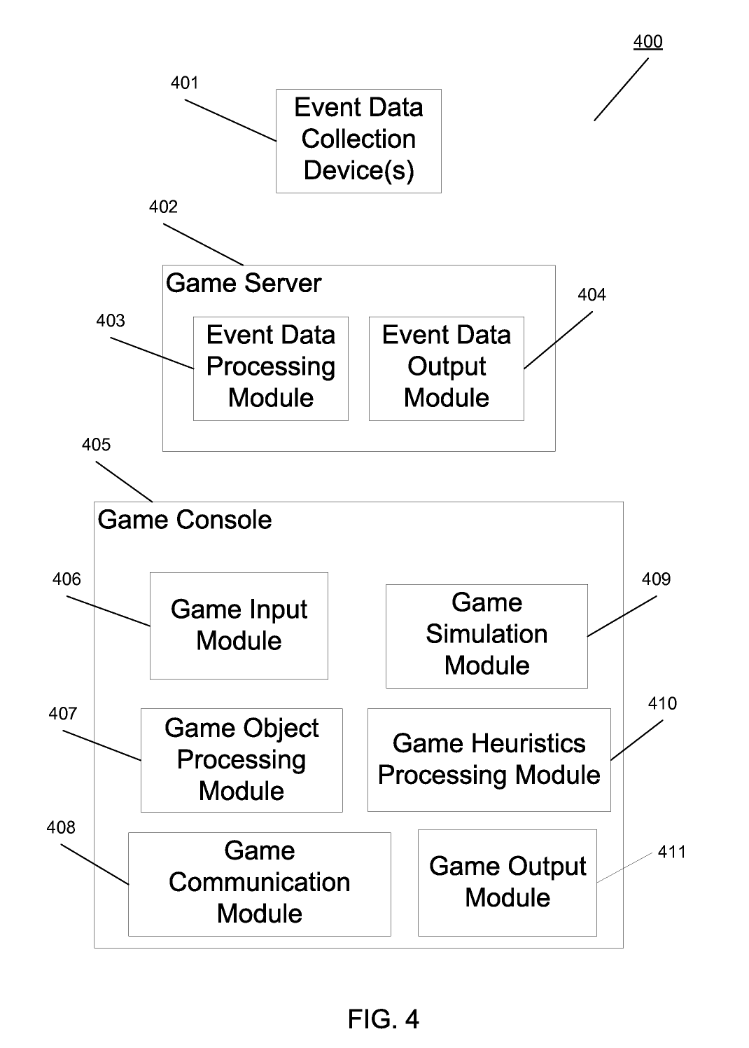

FIG. 4 is a block diagram 400 illustrating a system for collecting and simulating event data in accordance with the present invention. One or more event data collection devices 401 provide event data that can be processed by a game server 402. As discussed above, the data collection devices 401 can include tracking devices that can be track a player's position and speed, for example by being placed on a player's helmet or uniform. In an embodiment of the present invention, a game server 402 includes an event data processing module 403 for processing the event data, and an event data output module 404 which serves the data to game consoles 405. The processed event data can be output to the game console 405 in a game-friendly format which can be read and acted upon by a video game that is installed on a game console. Game console 405 is an example of game devices 104-107 that can be used in the game environment 100 shown in FIG. 1.

In an embodiment of the present invention, the game console 405 can include a game input module 406, a game simulation module 409, a game object processing module 407, a game heuristics processing module 410, a game communication module 408 and a game output module 411. The game input module 406 accepts the event data output from the game server 402, but also accepts game input from a game controller (not shown). The game simulation module 409 acts on the game input to simulate a game in accordance with how the game simulation module 409 is programmed, for example, in accordance with the particular game that is installed on the game console.

The game heuristics module 410 processes data relating to various heuristics associated with the game. The heuristics add a level of artificial intelligence to how the game operates. Game heuristics processing is useful for situations where the event data input has stopped or has been interrupted, but where the user would like to continue watching the game simulation output. For example, game heuristics can be used for interpolation and filling in gaps in game play and/or display due to interruptions in transmissions or in other cases where event date input has ceased.

Game heuristics provide a means for helping the game simulation figure out what it should do next based on the current input and/or current status of the game. Heuristics can be based on various algorithms for determining an outcome, for example, how to respond to a user's input based on his skill level or how to determine the chances of a particular event happening. Heuristics can be useful for presenting “what if” scenarios. For example, in a car racing game, what if the car did not crash, or in the game of football, what if one team made a first down during the last drive.

The game object processing module 407 processes game objects in accordance with input from the game simulation module 409 and/or the game heuristics module 410. The game communication module 408 provides a means for the game console to communicate with other consoles and with the Internet. The game output module 411 displays the simulated game data on the game console or any other available display.

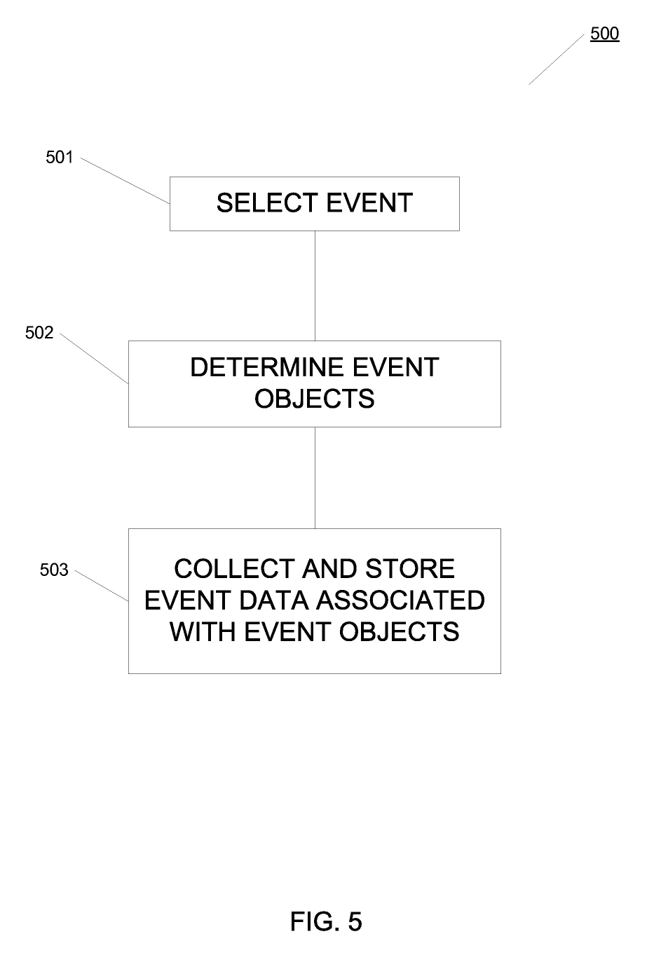

FIG. 5 is a flow diagram 500 illustrating a method for collecting event data. In an embodiment of the present invention, a game server accepts such collected data as input. Event data can be collected by selecting a desired event 501, determining a plurality of event objects 502, collecting the event data associated with the event objects and storing the collected data 503.

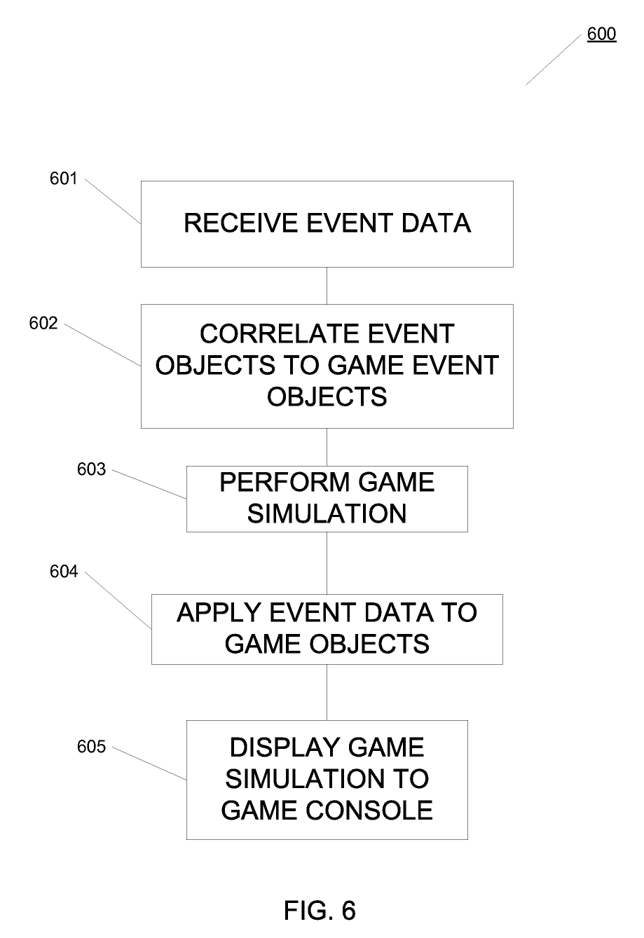

FIG. 6 is a flow diagram 600 illustrating a process for simulating event data in accordance with the present invention. In an embodiment of the present invention, this method can be performed by a game console which receives event data, 601, containing event object information. The game object processing module, described in the description of FIG. 4, correlates the event objects to game event objects, 602. This can be done by tagging the appropriate event objects and using the tags to determine appropriate game event objects.

The game console can then perform a game simulation, 603, using the game event objects, apply the event data to the event objects, 604, and then display the game simulation on the game console, 605. The result is a simulation of the event via the game console.

There are numerous examples of games and events for which such a method can be used. For example, a video game such as Tiger Woods™ published by Electronic Arts Inc. could be used to mimic a real golf tournament via the simulation described herein. The game currently contains three-dimensional models of golf courses around the world. If a tournament is played at Pebble Beach Resorts, the event can be simulated using this video game, because this particular course is already modeled in the game. All pertinent data collected about the golf tournament (players, scores, statistics, ball location) can be collected and processed by a game server. At home a user could insert the Tiger Woods™ video game DVD into a game console such as an Xbox™, and connect to the game server. The game server would send the collected event data to the user's game console for the game to use in reproducing a simulation of the live event. Each player's ball location can be accurately placed in the game, assuming that event data associated with each ball location has been collected. A player's golf stroke could be simulated in the game to represent how hard the ball was hit and where it landed and rolled. The players themselves could include three-dimensional models of themselves within the video game and can respond to the action. A user could watch the action as it takes place (or as the event data is received) or even play the same shot.

Such a game could be sold as a subscription service including seasons of tournaments. Single events could be sold on game media which would provide a user with the means for replaying an entire game from multiple viewpoints that are only limited by the amount of event data that was collected.

The application of this method can provide a wide variety of information to enrich the player's experience with the game. The game can display accurate digital representations of various golf courses. Players can be tracked as to their location on the course, and their shot can be depicted in the game. For example, given event data such as a starting location, a general ball flight (does the trajectory of the player's shots tend to fade or draw), and a finish location, the game can fill in the gaps and depict the flight of the ball as a result of player's shot.

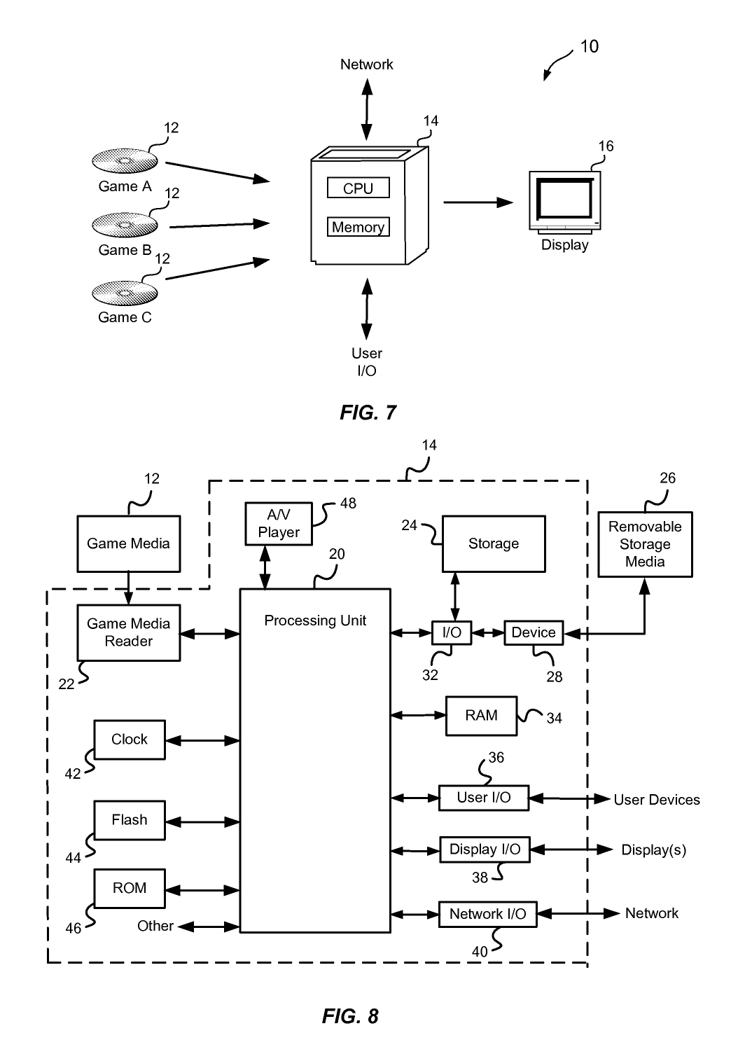

FIG. 7 illustrates a game system 10 for providing one or more games for a user according to one embodiment of the present invention. System 10 is shown including one or more game media 12 (game A, game B, game C), a game device 14, and a display 16.

One or more game media 12 can include any game applications that may be used by game device 14 to involve a user in a game. Each game medium 12 includes logic to provide a game, denoted as game A, game B, and game C. In one embodiment, the game provided by game device 14 is an electronic video game. Games are each individually stored on media, such as compact disk read-only memories (CDROMs), digital versatile disks (DVDs), game cartridges, or other storage media. A game, such as game A, is inserted in, coupled to, or in communication with game device 14 so that game device 14 may read all or part of a game application and/or related game data found on game media 12.

Game device 14 is a computing device that includes a processor, such as a CPU, and data storage combined or in separate elements. Game device 14 may be connected to a network that allows game device 14 to provide games that are not included on one or more game media 12. Thus, game A, game B, and game C may be accessed through the network and not be individually stored on game media 12. To allow a user to select from a plurality of available games, a display 16 might present a list of the games provided by game applications on game media 12. A game application may be also referred to as a game code and/or a game program. A game application should be understood to include software code that game device 14 uses to provide a game for a user to play. A game application might comprise software code that informs game device 14 of processor instructions to execute, but might also include data used in the playing of the game, such as data relating to constants, images and other data structures created by the game developer. A user interacts with the game application and game device 14 through user input/output (I/O) devices.

FIG. 8 illustrates an embodiment of game device 14 according to embodiments of the present invention. It should be understood that other variations of game device 14 may be substituted for the examples explicitly presented herein. As shown, game device 14 includes a processing unit 20 that interacts with other components of game device 14 and also interacts with external components to game device 14. A game media reader 22 is included that communicates with game media 12. Game media reader 22 may be a CDROM or DVD unit that reads a CDROM, DVD, or any other reader that can receive and read data from game media 12.

Game device 14 also includes various components for enabling input/output, such as an I/O 32, a user I/O 36, a display I/O 38, and a network I/O 40. I/O 32 interacts with a storage 24 and, through a device 28, removable storage media 26 in order to provide storage for game device 14. Processing unit 20 communicates through I/O 32 to store data, such as game state data and any shared data files. In addition to storage 24 and removable storage media 26, game device 14 includes random access memory (RAM) 34. RAM 34 may be used for data that is accessed frequently, such as when a game is being played.

User I/O 36 is used to send and receive commands between processing unit 20 and user devices, such as game controllers. Display I/O 38 provides input/output functions that are used to display images from the game being played. Network I/O 40 is used for input/output functions for a network. Network I/O 40 may be used if a game is being played on-line or being accessed on-line.

Game device 14 also includes other features that may be used with a game, such as a clock 42, flash memory 44, read-only memory (ROM) 46, and other components. An audio/video player 48 is also used to play a video sequence such as a movie. It should be understood that other components may be provided in game device 14 and that a person skilled in the art will appreciate other variations of game device 14.

While the invention has been described with respect to exemplary embodiments, one skilled in the art will recognize that numerous modifications are possible. For example, the processes described herein may be implemented using hardware components, software components, and/or any combination thereof. Thus, although the invention has been described with respect to exemplary embodiments, it will be appreciated that the invention is intended to cover all modifications and equivalents within the scope of the following claims.

What is claimed is:

1. A method for simulating an event via a video game, comprising:
receiving event data associated with a plurality of event objects;
associating the event objects with a plurality of game event objects;
performing a game simulation in accordance with the game event objects;
applying the event data to the plurality of game objects; and
displaying the game simulation.

2. The method of claim 1, wherein the event data includes position information associated with an event object.

3. The method of claim 1, wherein the event data includes orientation information associated with an event object.

4. The method of claim 1, wherein the game event object includes game simulation data.

5. The method of claim 1, wherein the game event object includes game heuristics.

6. The method of claim 1, wherein the game event object includes game simulation data and game heuristics.

7. A method for displaying an event via a video game, comprising:
receiving data collected from the event, wherein the event data includes at least one event object;
tagging the event object in accordance with predetermined data categories;
creating a game event object representing the tagged event object in accordance with a game event parameter;
applying the game event parameter to a game object; and
displaying the game object, wherein the game object provides a simulated representation of the event data.

8. The method of claim 7, wherein the game event parameter represents game simulation data.

9. The method of claim 7, wherein the game event parameter represents game heuristics.

10. A system for simulating an event via a video game, comprising:
an event data processing module responsive to event data input;
a game event object module responsive to the event data processing module to produce a tagged event data output;
a game simulation module responsive to the tagged event data output; and
a game output module responsive to the game simulation module to display simulated event data.

11. A system for simulating an event via a video game, comprising:
an event data processing module responsive to event data input;
a game event object module responsive to the event data processing module to produce a tagged event data output;
a game heuristics module responsive to the tagged event data output; and
a game output module responsive to the game simulation module to display simulated event data.

12. The system of claim 10, further comprising a virtual camera for viewing the simulated event data.

13. An apparatus for simulating an event via a video game, comprising:
means for receiving data collected from the event, wherein the event data includes at least one event object;
means for tagging the event object in accordance with predetermined data categories;
means for creating a game event object representing the tagged event object in accordance with a game event parameter;
means for applying the game event parameter to a game object; and
means for displaying the game object, wherein the game object provides a simulated representation of the event data.

14. A method for simulating event data via a video game, comprising:
receiving data the event data, wherein the event data includes a plurality of event objects;
tagging the event objects in accordance with at least one predetermined data category;
creating a game event object representing the tagged event object in accordance with a game event parameter;
applying the game event parameter to a game object; and
displaying the game object, wherein the game object provides a simulated representation of the event data.

15. The method of claim 14, wherein the predetermined data category includes position information.

16. The method of claim 15, wherein the predetermined data category includes orientation information.

17. The method of claim 15, wherein the predetermined data category includes heuristics information.
